(19) United States
(12) Patent Application Publication
(10) Pub. No.: US 2006/0213600 A1
(43) Pub. Date: Sep. 28, 2006

(54) Open-cell foam manufacturing method for composite thermoplastic elastomer materials with a sandwich structure

(75) Inventors: Chun-Hsiung Wu, Tainan City (TW); Ruey-Sheng Shih, Tainan City (TW)

Correspondence Address: BACON & THOMAS, PLLC, 625 SLATERS LANE, FOURTH FLOOR, ALEXANDRIA, VA, 22314, US

(73) Assignee: MICROCELL COMPOSITE COMPANY, Tainan City (TW)

(21) Appl. No.: 11/088,744

(22) Filed: Mar. 25, 2005

(51) Int. Cl. B32B 37/00

(52) U.S. Cl. 156/79

(57) ABSTRACT

An open-cell foam manufacturing method uses a thermoplastic elastomer material as a substrate and adds composites, foaming agents and crosslinking agents to produce a first external sheet and a second external sheet, and then forms a sandwich structure having the first external sheet, a reinforced layer and the second external sheet aligned and stacked in sequence to produce open-cell foam sheets with a sandwich structure. Threads are pressed on the surface of the foam sandwich structure by a roller to improve the slippery resistance of the foam material, which not only has high elasticity and slippery resisting property, but also creates a high tensile strength due to the fibers of the reinforced layer.

### FIELD OF THE INVENTION

The present invention generally relates to an open-cell foam manufacturing method, and more particularly to an open-cell foam manufacturing method for composite thermoplastic elastomer materials with a sandwich structure.

### BACKGROUND OF THE INVENTION

Conventional foams are generally divided into two kinds: a plastic foam and a rubber foam according to different raw materials used. Since the properties of these foams are different, therefore their applications are also different. For example, plastic foams usually adopt ethylene vinyl acetate (EVA) or a mixture of EVA and polyethylene (PE) as a main raw material for the plastic foam manufacturing process, and thus the produced plastic foams have the advantages of applying a simple formula and providing an easy coloration, in addition of its capability of forming complicated shapes for the finished goods easily at a later section of the manufacturing process. Further, the plastic foam manufacturing process and the applications of the plastic foam related products are quite mature now, and thus most materials such as shoe materials and doormat materials used in our daily life are made of the plastic foam materials. However, a plastic foam material does not come with good elasticity and slippery resistance.

As to the conventional rubber foam materials, a PVC/NBR mixture or other rubber material is adopted as the main raw material for its production under normal pressure (or atmospheric pressure) according to a traditional open-cell rubber foam manufacturing method. Although the rubber foams so produced have better elasticity and slippery resistance and can overcome the shortcomings of the aforementioned plastic foams, which is used extensively in the production of mouse pads, insoles or some of the doormat products, the formula of the rubber foam is more complicated, and the dusts produced during its manufacturing process causes pollutions to the environment. In addition, the tensile strength of rubber foams is decreased by the larger holes of the foams, and thus rubber foams cannot be used for an occasion that requires a high tensile strength.

Therefore, it is an important subject for the present invention to find a way to change the manufacturing process and produce open-cell foams with a high tensile strength under normal pressure, so as to effectively enhance the properties and applications of foams.

### SUMMARY OF THE INVENTION

In view of the long-existing shortcomings of prior art in rubber and plastic foams, the inventor of the present invention based on years of experience in the related field to conduct extensive researches and finally invented an open-cell foam manufacturing method for composite thermoplastic elastomer materials with a sandwich structure.

The primary objective of the present invention is to produce a roll of open-cell foam sheets by using a composite thermoplastic elastomer material as a substrate, adding composites, foaming agents and crosslinking agents of different functions, performing kneading and laminating processes to produce a first external sheet with predetermined width and thickness, and cooling and preparing said first external sheet for use; adding a composite agent, a foaming agent and a crosslinking agent with different functions to another composite thermoplastic elastomer material, and then performing the same kneading process and, while carrying out a laminating process to produce a second external sheet, a reinforced layer and said first external sheet are aligned and stacked with said second external sheet to produce a sandwich structure, and slightly pressing the sandwich structure by a roller into an integrated structure, and then sending the integrated structure into an oven, performing a foaming process under normal pressure, cooling the structure after the foaming process completes, and coiling the rolled structure by a wheel axle to produce open-cell foamed sheets.

Another objective of the present invention is to press threads on the surface of a foamed sandwich structure by a roller to produce open-cell thermoplastic foam materials with special threads as to effectively improve the slippery resistance of the foam material.

A further objective of the present invention is to produce a foam sandwich structure, not only having high elasticity and slippery resisting property of a regular rubber foam material, but also creating high tensile strength for the foam sandwich structure due to the fiber characteristic of the reinforced layer.

The above and other objects, features and advantages of the present invention will become apparent from the following detailed description taken with the accompanying drawings.

### BRIEF DESCRIPTION OF THE DRAWINGS

FIG. 1 is a flow chart of a manufacture process according to a preferred embodiment of the present invention.

### DETAILED DESCRIPTION OF THE PREFERRED EMBODIMENTS

An open-cell foam manufacturing method for composite thermoplastic elastomer materials with a sandwich structure in accordance with the present invention comprises the steps of using a composite thermoplastic elastomer material as a substrate, adding composites, foaming agents and crosslinking agents of different functions, performing kneading and laminating processes to produce a first external sheet with predetermined width and thickness, cooling and preparing the first external sheet for use, adding composites, foaming agents and crosslinking agents of different functions to a composite material having a thermoplastic elastomer substrate, and then performing the same kneading process to produce a rolled sheet, forming a sandwich structure comprised of a reinforced layer, the first external sheet, and then aligned and stacked with a second external sheet in sequence while producing a second external sheet, slightly pressing the reinforced layer, first external sheet and second external sheet by a roller into an integrated structure and then sending the integrated structure into an oven, performing a foaming process under normal pressure, cooling the sandwich structure after the foaming process completes, and coiling the rolled structure by a wheel axle to produce open-cell foam materials. Therefore, the present invention produces an open-cell foam material and such foam material not only has high elasticity and slippery resisting property of a regular rubber foam material, but also creates better tensile strength due to the structural property of the reinforced layer.

In the present invention, the first and second external sheets mainly use a styrenic thermoplastic elastomer as a substrate, such as styrene-butadiene-styrene (SBS), styrene-ethylene-butylene-styrene (SEBS), or styrene-isoprene-styrene (SIS), and other rubbers, thermoplastic elastomers or plastics are added to the substrated according to predetermined percentages by weight, and finally a foaming agent, a crosslinking agent and other agents are added according to perdetermined percentages by weight to produce the composite thermoplastic elatomer material of the present invention. The two external sheets may or may not adopt the same materials and formula, and the reinforced layer is mainly made of fabric materials such as yarns, unweaven cloth, artificial fiber cloth or other polymers, so that when the sandwich structure composed of the two external sheets and reinforced layer is pressed by a roller, the composite thermoplastic elastomer materials of the two external sheets penetrate into the gaps between the fabrics to assure the tight connections between the two external sheets with the reinforced layer during the foaming process.

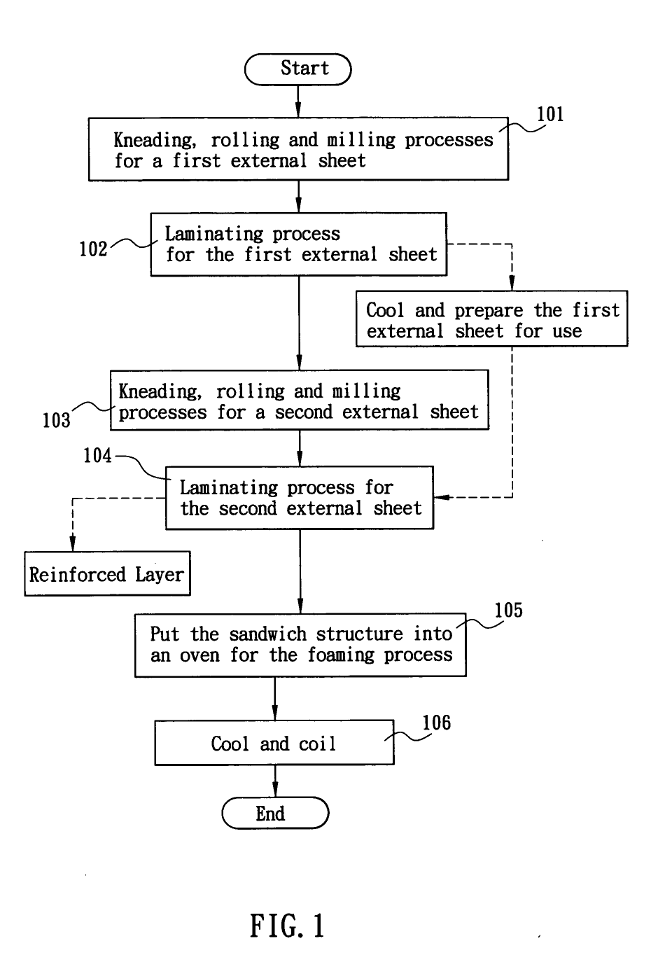

In a preferred embodiment of the present invention, a traditional open-cell rubber foaming method is adopted, which uses traditional kneading, laminating and foaming devices to carry out the following procedure as shown in FIG. 1. The composition of the composite thermoplastic elastomer materials are kneaded, laminated and foamed as follows:

(101) Firstly, the ingredients of the composite thermoplastic elastomer materials with predetermined percentages by weight according to the present invention are placed sequentially into the devices such as a kneader, a roll mill, a two-roll mill or a Banbury mixer and mixed in these devices at a temperature of approximately 90° C. to 130° C.;

(102) The mixed composite thermoplastic elastomer materials are sent to a three-roll laminating device for pressing and controlling the width and thickness, so as to produce the first external sheet with continuous length and required width and thickness for the use at a later stage of the process after the first external sheet is cooled;

(103) Afterward, the ingredients of the composite thermoplastic elastomer materials with the same or different formula are placed sequentially into a kneader or a roll mill, and go through the same kneading and milling process for producing the second external sheet;

(104) The mixed materials for the second external sheet is placed into the three-roll laminating device for pressing a sandwich structure composed of the reinforced layer and the first external layer aligned and stacked onto the second external sheet, and the assembled structure is pressed slightly by a roller into an integrated structure to produce a non-foam sandwich structure;

(105) The open-cell sandwich structure is placed into an oven with a temperature of approximately 150° C. to 180° C. and under normal atmospheric pressure for the foaming process of the sandwich structure. After being placed in the oven for appropriate time (which is usually about 10 to 30 minutes, depending on the size and thickness of the open-cell sheet), the sandwich structure is removed from the oven when the foaming process ends;

(106) Finally, the foamed open-cell sandwich structure is cooled and rolled by a wheel axle to produce a roll of open-cell foam sheets.

In this embodiment, the composite thermoplastic elastomer material used for the two external sheets includes the following ingredients, but these ingredients can be changed according to actual needs, so that the two external sheets have different physical properties:

(1) Styrenic thermoplastic elastomer: This ingredient is a substrate made of composite materials and occupies about 50% to 100% of the total weight, which could be styrene-butadiene-styrene (SBS), styrene-ethylene-butylene-styrene (SEBS), styrene-isoprene-styrene (SIS) and styrene-ethylene/propylene-styrene (SEPS)

(2) Chemical foaming agents: This composition occupies about 1% to 5% of the total weight, which could be a physical foaming agent such as azo foaming agent or soda powder.

(3) Crosslinking agents: This ingredient occupies about 0.1% to 1% of the total weight and could be dicumyl peroxide, 2,5-(tert-butylperoxide)-2,5-dimethylhexane or sulfur.

In this embodiment, the material used for the reinforced layer can be changed to yarns, unweaven cloth, other artificial fiber cloth or other polymers such as styene polymers with different thicknesses and deniers according to actual needs. Further, the composite materials used in actual applications are not limited to the aforementioned compositions, but also could add the following ingredients into the composite thermoplastic elastomer material according to the required functions, features or actual needs to produce the two external sheets for the invention:

(1) Other polymers: The ingredient is a substrate made of a composite material and occupies about 0% to 50% of the total weight, which could be Styrene Butadiene Resin (SBR), Polystyrene (PS), Ethylene Vinyl Acetate (EVA), Low Density Polyethylene (LDPE), Ethylene Propylene Diene Monomer (EPDM) to change the properties of the foaming material and satisfy the actual requirements.

(2) Functional composites: This ingredient occupies about 0% to 50% of the total weight of the polymer materials (including styrenic thermoplastic elastomers and other polymers, which could be anti-static agents, flame retardants or reinforcers to improve the physical properties of the foaming materials.

(3) Foaming agents: This ingredient occupies 0% to 3% of the total weight of the main polymers, which could be zinc oxide or urea to enhance the effect and speed of the foaming process.

(4) Other additives: This ingredient includes a manufacturing oil, stearic acid or zinc stearate as the manufacturing agent, or a dye, calcium carbonate and wood flour as an expander to change the properties of the foams and show the visual effects.

In summation of the description above, the open-cell foam manufacturing method for composite thermoplastic elastomer materials with a sandwich structure in accordance with the present invention not only has high elasticity and slippery resisting effect of the general rubber foams, but also has a feature of the reinforced layer to improve tensile strength. In addition, threads can be pressed on the surface of the foams by a roller, and thus open-cell foams with good tensile strength and special threads on the surface can be rolled after cooling, so as to improve the slippery resisting effect of the foams.

While the invention herein disclosed has been described by means of specific embodiments, numerous modifications and variations could be made thereto by those skilled in the art without departing from the scope and spirit of the invention set forth in the claims.

What is claimed is:

1. An open-cell foam manufacturing method for composite thermoplastic elastomer materials with a sandwich structure, comprising the steps of:
adding a composite agent, a foaming agent and a crosslinking agent with different functions to a composite thermoplastic elastomer material, and then performing kneading and laminating processes to produce a first external sheet with predetermined width and thickness, and cooling and preparing said first external sheet for use;
adding a composite agent, a foaming agent and a crosslinking agent with different functions to another composite thermoplastic elastomer material, and then performing a kneading process and mixing ingredients, and carrying out a laminating process to produce a second external sheet, such that a reinforced layer and said first external sheet are aligned and stacked with said second external sheet to produce a sandwich structure, and said sandwich structure is comprised of said first external sheet, said reinforced layer and said second external sheet coupled in sequence, and said sandwich structure is slightly pressed by a roller to form a non-foam sandwich structure;
putting said sandwich structure into an oven under normal pressure to perform a foaming process for said sandwich structure, and removing said sandwich structure from said oven after an appropriate time period; and cooling said open-cell foam sandwich structure, and rolling said open-cell foam sandwich structure by a wheel axle to produce a roll of open-cell foam sheets.

2. The open-cell foam manufacturing method for composite thermoplastic elastomer materials with a sandwich structure of claim 1, wherein said thermoplastic elastomer adopts a styrenic thermoplastic elastomer as a substrate and said thermoplastic elastomer is one selected from the collection of styrene-butadiene-styrene (SBS), styrene-ethylene-butylene-styrene (SEBS), styrene-isoprene-styrene (SIS) and styrene-ethylene/propylene-styrene (SEPS) with a composition of 50% to 100% by weight.

3. The open-cell foam manufacturing method for composite thermoplastic elastomer materials with a sandwich structure of claim 2, wherein said composite thermoplastic elastomer material with different ingredients according to predetermined percentages by weight is placed into a traditional kneader and roll mill device for kneading, rolling, milling and mixing processes at a temperature of approximately 90° C. to 130° C.

4. The open-cell foam manufacturing method for composite thermoplastic elastomer materials with a sandwich structure of claim 3, wherein said oven is heated to a temperature of approximately 150° C. to 180° C. under normal pressure for performing a foaming process to said open-cell sheet and producing a foaming material, so as to produce said open-cell foam sandwich structure after a time period.

5. The open-cell foam manufacturing method for composite thermoplastic elastomer materials with a sandwich structure of claim 2, wherein said foaming agent is an azo foaming agent, a soda powder, or a physical foaming agent having a composition of approximately 1% to 15% by weight.

6. The open-cell foam manufacturing method for composite thermoplastic elastomer materials with a sandwich structure of claim 5, wherein said crosslinking agent is dicumyl peroxide, 2,5-(tert-butylperoxide)-2,5-dimethylhexane or sulfur with a composition of approximately 0.1% to 1% by weight.

7. The open-cell foam manufacturing method for composite thermoplastic elastomer materials with a sandwich structure of claim 6, wherein said composite thermoplastic elastomer material further comprises a polymer, and said polymer is one selected from the collection of styrene butadiene resin (SBR), polystyrene (PS), ethylene vinyl acetate (EVA), low density polyethylene (LDPE), ethylene propylene diene monomer (EPDM) with a composition of approximately 0% to 50% by weight.

8. The open-cell foam manufacturing method for composite thermoplastic elastomer materials with a sandwich structure of claim 6, wherein said composite thermoplastic elastomer material further comprises a foaming agent, and said foaming agent is zinc oxide or urea and has a weight of approximately 0% to 3% of the total weight of said styrenic thermoplastic elastomer and other polymers.

9. The open-cell foam manufacturing method for composite thermoplastic elastomer materials with a sandwich structure of claim 6, wherein said composite thermoplastic elastomer material further comprises other manufacturing agent of steric acid or zinc stearate.

10. The open-cell foam manufacturing method for composite thermoplastic elastomer materials with a sandwich structure of claim 6, wherein said composite thermoplastic elastomer material further comprises a dye, calcium carbonate and wood flour as an expander.

11. The open-cell foam manufacturing method for composite thermoplastic elastomer materials with a sandwich structure of claim 6, wherein said composite thermoplastic elastomer material further comprises a functional composite agent selected from the collection of an anti-static agent, a flame retardant, and a reinforcer having a weight of approximately 0% to 50% of the total weight of said styrenic thermoplastic elastomer and other polymers.

12. The open-cell foam manufacturing method for composite thermoplastic elastomer materials with a sandwich structure of claim 1, wherein said reinforced layer adopts a material selected from further comprises a yarn, an unweaven cloth, an artificial fiber cloth, or a polymer material with different thicknesses and deniers.

13. The open-cell foam manufacturing method for composite thermoplastic elastomer materials with a sandwich structure of claim 12, wherein said polymer is a styrenic polymer.

14. The open-cell foam manufacturing method for composite thermoplastic elastomer materials with a sandwich structure of claim 1, wherein said foam material has a thread treatment on its surface performed by a roller, and said foam material is rolled into a roll of open-cell foam sheets by a wheel axle after a cooling process.
